(19) United States
(12) Patent Application Publication
(10) Pub. No.: US 2009/0290286 A1
(43) Pub. Date: Nov. 26, 2009

(54) Mica capacitor and fabrication method of the same

(76) Inventors: Eui Jung Yun, Asan-si (KR); Cheal Soon Choi, Gongju-si (KR); Nho Kyung Park, Seongnam-si (KR)

Correspondence Address: Royal W. Craig, Esq;Ober/Kaler, 120 East Baltimore Street, Baltimore, MD, 21202-1643, US

(21) Appl. No.: 12/317,614

(22) Filed: Dec. 24, 2008

(30) Foreign Application Priority Data
May 21, 2008 (KR) 10-2008-0047104

(51) Int. Cl. H01G 4/08; H01G 7/00

(52) U.S. Cl. 361/325; 29/25.42

(57) ABSTRACT

The mica capacitor and fabrication method there for, resulting in parallely stacking basic laminates in which an electrode sheet is arranged between parallely stacked mica sheets to protrude in a zigzag manner, arranging an insulation plate in which the basic laminates are parallely stacked where the insulation plate protruding in a zigzag manner is formed between the basic laminates, and filling a conductor between insulation protrusions, whereby a parallel connection is implemented on the basic laminates themselves while a serial connection is implemented between the basic laminates, thereby enabling a provision of mica capacitor having a high voltage property.

### CROSS-REFERENCE TO RELATED APPLICATION

The present application derives priority from Korean Application Number 10-2008-0047104, filed May 21, 2008, the disclosure of which is incorporated by reference herein in its entirety.

### BACKGROUND OF THE INVENTION

1. Field of the Invention

The present disclosure relates to a capacitor and fabrication method of the same, and more particularly to a mica capacitor and fabrication method of the same capable of warranting an excellent insulation characteristic, particularly under a high voltage environment and a safety against an external environment by effectively stacking micas.

2. Description of the Background

A capacitor or a condenser is a device for collecting an electric field in a space between two conductive materials. The capacitor generally includes two conductor plates and is disposed with an insulator (a dielectric) between the two conductive plates. Capacitors are classified according to the kinds of insulators used. An insulation characteristic of each insulation material is shown in the following Table.

| Insulation material | Breakdown voltage (over kv/mm) |
|---|---|
| Mica | 150 |
| Glass | 38 |
| Ceramic | 96 |
| Graphite | 2 |
| Silicon rubber | 23 |
| Ebonite | 25 |
| Insulation tape | 5 |
| Alumina | 10~16 |
| Natural rubber | 20~30 |
| Phenol resin | 8~14 |
| Acrylic resin | 17.7~21.6 |
| Polyethylene resin | 18~25 |
| Epoxy resin | 16~20 |

Mica, a mineral, is one of the oldest dielectric materials used in capacitor construction. Mica is very stable electrically, mechanically, and chemically. It has a dielectric constant in the range 5-7. The crystalline structure of Mica is asymmetrical, and so while the binding forces in one plane are strong, those along a perpendicular plane are very weak. This results in a characteristic layered structure, which makes it possible to split or cleave mica into very thin, optically flat, sheets. For capacitors, mica sheets in the range 0.025-0.125 mm or even thinner are used.

Referring to Table 1, it can be noted that the insulation characteristic of mica is very high over other materials. Capacitors using mica for its excellent insulation characteristic may be further classified into two types: one being made of aluminum foil or tin foil alternatively overlapped with mica plates and immersed in resin; and the other being silvered mica plates manufactured by silver sintered onto mica plates by chemical processes or electrochemical processes. These silver-(electroplated) mica capacitors have distinct advantages in that their capacitance is less prone to change with fluctuations in temperature, they have a high insulation resistance, and are useable in high frequency applications (they are widely used as a low-capacity capacitors).

However, there is a trend toward higher-voltage facilities and environments due to the development of industrial infrastructure. High capacity motors, electric motors and insulation monitoring devices for high powered systems are in increasing demand as a result of this development of industrial infrastructure and large scale urbanization. Although a higher voltage is used for high voltage systems in special environments, the high voltage cannot be applied to the high voltage system as is. In such cases a circuit capable of blocking or coupling a high primary voltage is very important. This is due to the fact that it is impossible to apply a high primary voltage corresponding to an alternating current ranging from several kilovolts to several thousand kilovolts to a system without a configuration of circuitry to limit the high primary voltage.

In general, high voltage capacitors are manufactured using ceramic in a repeated process of alternately overlaying patterned ceramic layers with patterned electrode layers, and laminating the layers together with pressure and heat. The ceramic is sintered either between subsequent layers or in a single sintering.

Mica capacitors have various excellent properties when compared to ceramic capacitors, and can improve or increase reliability and obviate various external environmental problems making use of the excellent properties shown in Table 1. In other words, ceramic capacitors have the disadvantages of poor high voltage reliability, and particularly in light of their high sensitivity to temperature changes, whereas mica capacitors hardly suffer at all from electrical property changes resultant from temperature changes. To be more specific, the ceramic capacitor exhibits changes of several tens of percentages when temperature varies between −55 degrees Celsius to 135 degrees Celsius, whereas the mica capacitors show a small change of less than one percent. In addition, mica capacitors also have excellent properties of very high stability relative to internal resistance and loss change resulting from temperature change.

However, the same mica capacitors that exhibit such excellent insulation properties and high stability relative to the external environment have limited application as high voltage capacitors due to structural shortcomings. Hereinafter, measures to overcome the structural problems of the mica capacitor will be described.

### SUMMARY OF THE INVENTION

Accordingly, the present disclosure has been made to solve the above problems occurring in the prior art, and it is an object of the present disclosure to provide a high voltage mica capacitor with simplified structure by a simplified fabrication process.

In one general aspect of the present disclosure, a mica capacitor comprises a basic laminate including parallely stacked mica sheets and electrode sheets, the latter being alternatively arranged between the mica sheets to protrude in a zigzag manner; an insulation plate alternatively arranged between the parallely-stacked basic laminates to protrude in a zigzag manner (insulation protrusion); and a conductor filled-in between the insulation protrusions facing same direction to allow only protruded portions of the electrode sheets in the basic laminate to be short-circuited.

Preferably, an opposite side of the protruded portions on the electrode sheet is sunk between the mica sheets. Preferably, the conductor is also filled in the uppermost basic laminate and the lowermost basic laminate of the stacked basic laminate toward the insulation protrusion. At this time, preferably, the conductor filled only in the uppermost basic laminate and the lowermost basic laminate is connected to outside. Preferably, an upper surface of the uppermost basic laminate and a lower surface of the lowermost basic laminate are additionally arranged with the insulation plate.

Preferably, the conductor is a lead. Preferably, the electrode sheet is a silver/conducting polymer composite (Ag paste) or an electrode paper. Preferably, the mica sheet is in the thickness range of 0.01 mm˜0.1 mm. Preferably, the mica capacitor further includes a molding insulation that molds the basic laminate, the insulation plate and the conductor, where the molding insulation is preferably made of epoxy material.

In another general aspect of the present disclosure, a fabrication method of mica capacitor comprises: forming a basic laminate in which an electrode sheet is arranged between parallely stacked mica sheets to protrude in zigzag style; arranging an insulation plate in which the basic laminates are parallely stacked, and an insulation plate protruding in zigzag style is formed between the basic laminates; and filling a conductor between insulation protrusions each protruded toward the insulation plate.

Preferably, the fabrication method further comprises connecting terminals to a conductor filled only in an uppermost basic laminate and a lowermost basic laminate.

Preferably, the fabrication method further comprises molding the basic laminate, the insulation plate and the conductor in their entirety using molding insulation. Preferably, the conductor is a lead.

As mentioned above, the mica capacitor according to the present disclosure can realize a desired electrostatic capacity using a parallel structure, and can realize a high voltage using a serial structure, whereby the mica capacity can be simply structured and fabricated.

### BRIEF DESCRIPTION OF THE DRAWINGS

FIG. 1 is a cross-sectional view illustrating structure of a mica capacitor according to an exemplary implementation of the present disclosure.

FIG. 2 is a plan and a lateral view illustrating a stacked state of a basic laminate of FIG. 1.

FIG. 3 is an equivalent circuit conceptual drawing of a mica capacitor of FIG. 1.

FIG. 4 is a schematic diagram illustrating a connected state of an entire electrode relative to FIG. 1.

FIG. 5 is a flowchart illustrating a mica capacity fabricating process according to an exemplary implementation of the present disclosure.

### DETAILED DESCRIPTION

The exemplary implementations of the present disclosure will be described in detail with reference to the accompanying drawings.

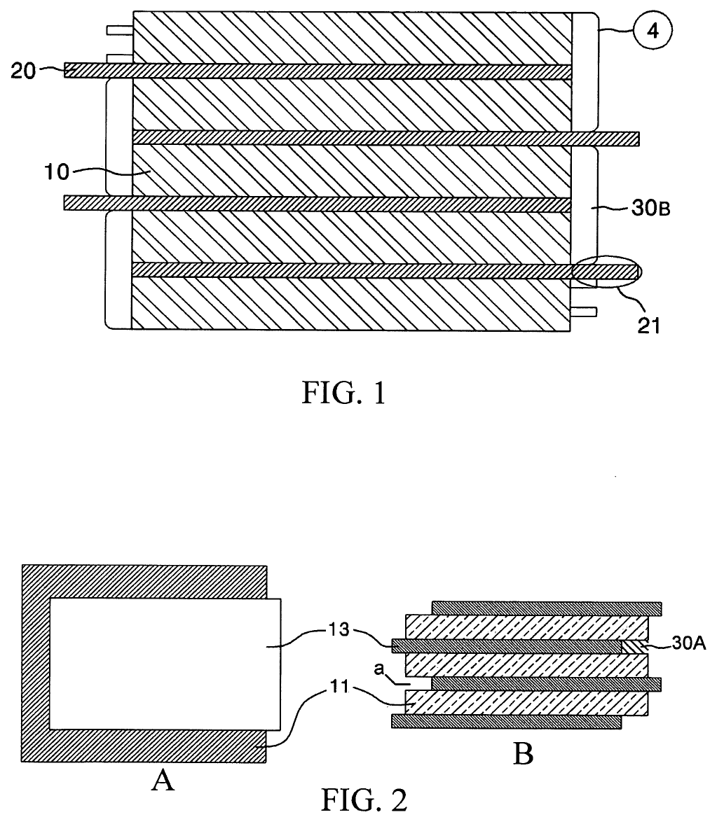

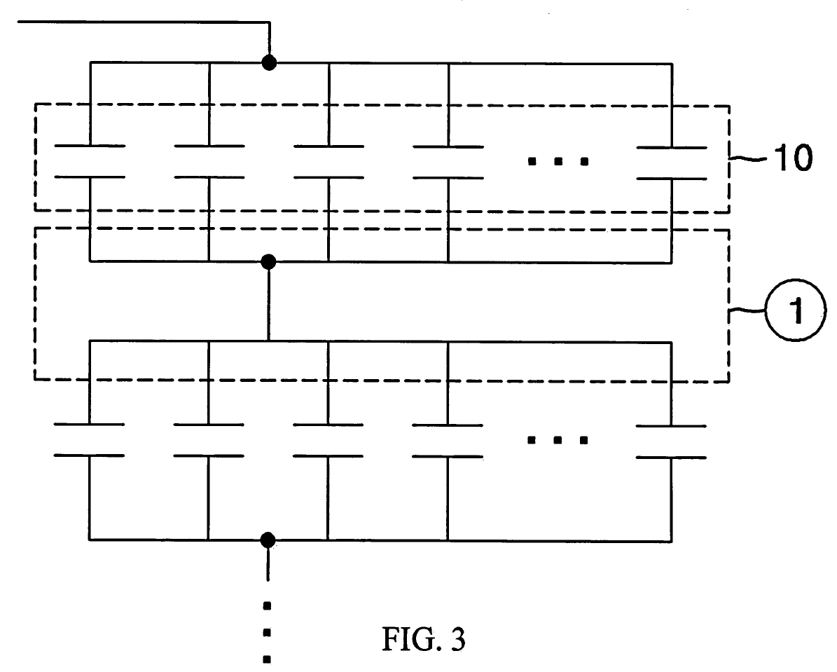

FIG. 1 is a cross-sectional view illustrating the structure of a mica capacitor according to an exemplary implementation of the present disclosure. Referring to FIG. 1, a mica capacitor may comprise one or more parallel-stacked basic laminate layers (10), each in turn formed from parallely stacked mica sheets alternately stacked with electrode sheets, the electrode sheets alternatively arranged between the mica sheets and protruding lengthwise there from, first at one end and then at the other, so as to protrude in a zigzag manner as described in detail below with regard to FIG. 2 (the electrode protrusions). Similarly, the mica capacitor includes insulation plates (20) alternatively arranged between the parallely-stacked basic laminates (10) and protruding lengthwise there from, first at one end and then at the other, so as to protrude in a zigzag manner as shown (the insulation protrusion (21)). At the opposite non-protruding ends, the insulation plate (20) together with flanking laminate layers (10) are covered by a conductor (30B) that spans to the insulation protrusions (21), effectively short-circuiting all the protruding electrode sheets within the corresponding laminate layer (10) that protrude into contact with conductor (30B).

Now, referring to FIG. 2, a plan view A and a lateral view B are shown of a parallel-stacked basic laminate layer (10), which comprises a plurality of stacked mica sheets (11) alternately stacked with electrode sheets (13). The plurality of mica sheets (11) are parallely stacked. The electrode sheets (13) are likewise parallely stacked, alternatively arranged between respective mica sheets (11), and offset there from in a zigzag manner. In the illustrated embodiment, the electrode sheets (13) are alternatively arranged between the mica sheets (11) and are offset lengthwise there from, first toward one end and then toward the other, so as to protrude in a zigzag manner., e.g., one alternatively-arranged electrode sheet (13) having a protruded portion on one side while the next electrode sheet (13) has a protruded portion on the other side, as shown in FIG. 2.

Referring again to FIG. 2, conductor (30A) is filled into the gaps (a) occurring at the short ends of the protruded electrode sheets (13) between opposing mica sheets (11), such that that the basic laminate (10) comprised of mica sheets (11) and electrode sheets (13) has a substantially quadrilateral form and capacitance determined by the number and thickness of stacked mica sheets (11) and electrode sheets (13). It should be readily apparent to one skilled in the art that the thickness and the number of stacks may be determined to conform to the desired capacitance.

It is practically impossible to process a mica sheet (11) at a thickness of less than 0.01 mm. Conversely, if the thickness of a mica sheet (11) is greater than 0.1 mm, an electrostatic capacity value per unit area of the mica sheet (11) becomes very low making it difficult if not impossible to realize a high voltage mica capacitor. Therefore, it is preferable that the thickness of the mica sheets (11) be in the range of from 0.01 mm˜0.1 mm, such that an appropriate thickness must be selected between the ranges.

Preferably, the thickness of electrode sheets (13) is in the range of 0.025 mm˜0.05 mm, which is a dimension capable of fabrication. If the thickness of the electrode sheet (13) is greater than 0.05 mm, there is a possibility of generating a void due to thickness of the electrode sheet (13). The void may become a direct cause of voltage failure when a high voltage is applied, and so a thickness of less than 0.05 mm is preferable.

The mica sheets (11) and the electrode sheets (13) may be bound by a combination of heat and pressure, wherein the pressure is in the range of 1000 C˜1500 C, with a preferable pressure of 80 kg/cm². Trapped air is vacated under these conditions. In particular, it has been found that the most effective temperature at the stated pressure is 1300 C, and such pressure does not damage the sheets.

Referring to FIG. 2, it can be seen that the area of electrode sheets (13) is smaller than that of mica sheets (11), whereby an area of mica sheet (11) not covered by the electrode sheet (13) is visible in the left plan view A. The size of this exposed area effects capacitance, and so the exposed area must also be designed in accordance with the desired electrostatic capacity.

The protruding electrode sheets (13) in the right side B of FIG. 2 results in a gap (a) at their non-protruding ends, between opposing mica sheets (11). The gap (a) forms a space of predetermined size between the adjacent mica sheets (11). This gap (a) is covered by the conductor 30A, which is deposited to protect the electrode sheet (13) (that is not protruded) from being short-circuited at that end. Both the gap (a) and conductor (30A) protect against shorting, and this is helpful as against over-charging pressure. It is essential that the non-protruding ends of the electrode sheets (13) never be charged during conventional charging methods, and the above-described configuration helps achieve this. In addition, the above-described structure is easier to fabricate inasmuch as the protruding ends of electrode sheets (13) are needed for contact, and these as well as the gap (a) are formed simply by offsetting the stacked mica sheets (11) and electrode sheets (13). However, one skilled in the art should understand that there may be other configurations that achieve these design goals within the scope and spirit of the invention, and so the non-protruding end of electrode sheets (13) need not absolutely form a gap (a) or be protected by insulation 30A.

As mentioned above, the protruding ends of the electrode sheets (13) within the basic laminate (10) protrude in order to serve as electrical contacts, and so alternate ones of the electrode sheets (13) serve as a (+) terminal while the others serve as a (−) terminal, the mica capacitor effectively may be having a parallel structure the capacitance of which depends on the number of stacked mica sheets (11) and electrode sheets (13), as a matter of design choice.

Preferably, the electrode sheets (13) are Ag paste or electrode paper. The insulation plates (20) are alternatively protruded in the parallely stacked basic laminate in a zigzag manner (insulation protrusion 21) and a plurality of conventional insulating laminates are available for this purpose. Preferably, the insulation plates (20) are made of mica, and their non-protruding ends are aligned (unlike the electrode sheets (13)) with the distal end of the basic laminate (10) for insulation between the basic laminates (10).

Referring again to FIG. 1, conductor (30B) is filled into the space between the insulation protrusions (21), the space being defined by opposed insulation protrusions 21 in the same direction. It is important that the conductor 30B be filled in so as only to short-circuit the protrusions of the electrode sheets (13) in the basic laminate (10). That is, there is no problem if the conductor (30B) is filled in at the mica sheets (11) corresponding to insulation in the basic laminate (10), but if the conductor (30B) contacts the non-protruded portions of the electrode sheets (13), the mica capacitor may lose some of its function as a capacitor. Therefore, conductor (30B) should be filled in the electrode sheet (13) having a protrusion only. At this time, it may be difficult to fill in the conductor (30B) only in the protruded portions (including mica sheet) in the electrode sheet (13), and that is why the non-protruding sides of the electrode sheets (13) are gapped (a), to facilitate the filling-in of the conductor (30B), as described in the foregoing.

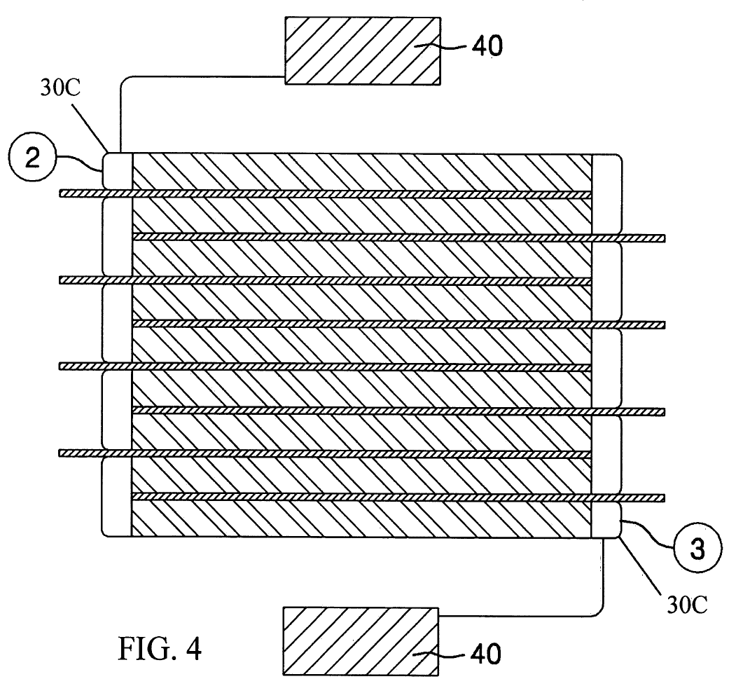

As illustrated in FIG. 3, the resulting electrical circuit implemented by the foregoing is a parallel connection of the layers within each basic laminate (10) through the conductors (30A), and serial connections of the basic laminate layers (10) through the conductor (30B) filled in between the insulation protrusions 21.

The electrode sheets in the basic laminate (10) in FIG. 3 are represented as capacitors where terminals are not connected, but the protruded portions of the electrode sheets (13) are short-circuited by the conductor (30A) to form the parallel connection as shown in \textcircled{1} of FIG. 3. The connection \textcircled{1} of FIG. 3 may be an entire output terminal of a predetermined basic laminate (10) and at the same time an entire input terminal of another basic laminate (10), such that according to a simple structure of the mica capacitor, a desired electrostatic capacity may be obtained by the parallel structures, and a high voltage may be obtained by the serial structures.

For reference, the terminal electrode sheets (13) shown in FIG. 1 may be attached by soldered leads, where the soldering temperature is preferably in the range of 1800 C˜2500 C when a conventional lead is used. However, the soldering temperature is preferably in the range of 2300 C˜2500 C when a highly reliable lead is used in order to prevent failure in the soldering.

The above description has described filling-in of conductor (30B) between insulation protrusions (21). There is a need of processing an uppermost layer and a lowermost layer in the basic laminate (10) that are irrelevant to spaces between the insulation protrusions (21), which may be solved by filling-in in the direction of insulation protrusion (21) as shown at \textcircled{4} of FIG. 1. It may be possible to additionally attach an uppermost insulation plate (20) to the uppermost surface of the uppermost layer shown in FIG. 1, and as well to the lowermost surface of the lowermost layer in the basic laminate (10) purely for convenience in the conductor (30B) filling process.

The uppermost layer of basic laminate (10) and the lowermost layer of basic laminate (10) may be filled in with conductor (30C) of their own, unlike the other layers of basic laminates (10) that are formed between the uppermost and lowermost basic laminates, as shown in \textcircled{2} and \textcircled{3} of FIG. 4. The conductor (30C) filled only in the uppermost and lowermost layers of basic laminate may be connected to outside. The outside connection may be a terminal electrode of the entire mica capacitor, and may be connected to a predetermined external terminal 40 if necessary.

Preferably, the mica capacitor further includes an external molding that surrounds the basic laminate, the insulation plate, and the conductor. Under this circumstance, the molding insulation may be made of conventional epoxy material. The molding insulation may be injected into a capacitor case enclosing the mica capacitor (including the basic laminate (10), the insulation plates (20) and the conductors), giving due consideration of capacitor insulation characteristics and magnetic influence, and may be cured there inside. A suitable high voltage insulation epoxy such as ER 9030 may be used for a high voltage mica capacitor. The high voltage insulation epoxy ER 9030 may initially be cured for 4˜6 hours at 800 C for natural de-airing and impregnation, and may be secondarily cured for 24 hours at 1250 C, such that a complete curing can be performed.

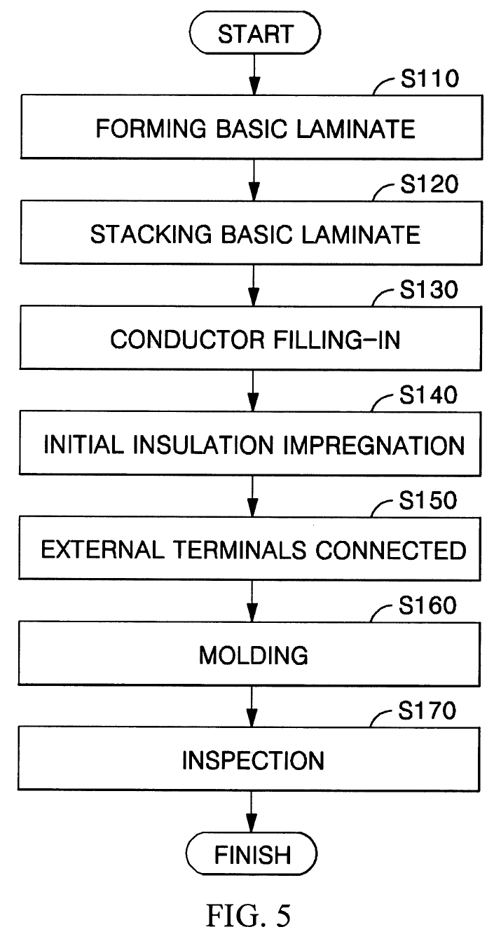

Now, a fabrication method of mica capacitor according to the present disclosure will be described with reference to FIG. 5.

The fabrication method of mica capacitor may comprise the steps of: 1) forming a basic laminate (10) in which an electrode sheet (13) is arranged between parallely stacked mica sheets (11) to protrude in a zigzag manner (S110); 2) arranging an insulation plate (20) in which the basic laminates (10) are parallely stacked, the insulation plate(s) (10) protruding in a zigzag manner between the basic laminates (S120); and 3) filling a conductor (30b) between insulation protrusions each protruded toward the insulation plate (10) (S130).

Following the above three steps, the fabrication method may further include a fourth step of initial insulation impregnation (S140), where epoxy is used for insulation of each element and vacuum impregnation is performed, whereby stacked elements are cured, property values such as capacitance, loss value, insulation resistance and voltage-resistance property are corrected, and inner air and impurities which are the causes for generating failures are removed. Preferably, epoxy curing is performed at 1500 C for an hour to allow epoxy which is an insulation material to be fully impregnated into each space between the mica sheets.

Next, at a fifth step, successive external terminals are connected (S150) to the conductor (30C) filled into the basic laminate layers (10), where the terminals are connected to the conductor (30C) filled only in the uppermost and lowermost basic laminate layers (10). Soldering is very important in connecting the external terminals. The structure being involved with a high voltage, it is preferred that soldering temperature, terminal connection status and coupling relations of each terminal be reliably controlled. It is also preferable that the soldered status, dimensions after element connection and external coupling be well controlled.

Finally, at a sixth step (S160) a molding process is performed using molding insulation, and an inspection to check if the mica capacitor functions according to the purpose is performed at (S170) for the completion of the fabrication method. The inspection may include checking if a desired voltage resistance property (e.g., 54,000 kV) has been obtained through the serial connection between the basic laminates (10), a desired capacity (e.g., 50˜5000 pF) has been acquired through the parallel connection, and the loss value satisfies an upper limit (e.g., 0.05), as the basic laminate comprising mica sheets each thickness of less than 0.1 mm cannot tolerate a voltage limit of 10 kV. If necessary, a vacuum de-airing process may be performed after the molding process.

In recap, the fabrication method of mica capacitor may include parallely stacking basic laminates in which an electrode sheet is arranged between parallely stacked mica sheets to protrude in a zigzag manner, arranging an insulation plate in which the basic laminates are parallely stacked where the insulation plate protruding in a zigzag manner is formed between the basic laminates, and filling a conductor between insulation protrusions, whereby a parallel connection is implemented on the basic laminates themselves while a serial connection is implemented between the basic laminates, thereby enabling a provision of mica capacitor having a high voltage property. In addition, the uppermost and lowermost basic laminates may be connected by external terminals for a mount with external electrodes. A case of mica capacitor may be disposed therein with a capacitor laminate comprising the basic laminate, the insulation plate and a conductor. The case may be then molded to cap with the fabrication of the mica capacitor.

The mica capacitor may be applied to a field where a capacitor requiring a high voltage property is necessary, and particularly, the mica capacitor may be utilized in various industrial fields requiring an excellent insulation property because the mica capacity has a characteristic of little change in electrical property to temperature changes. For example, electric power stations, substations, power transmission sites and central power control systems in various buildings may utilize the mica capacitor.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singularly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A mica capacitor, comprising:
a plurality of parallely and alternately stacked basic laminate layers and insulation plates, each basic laminate layer being formed of parallely stacked mica sheets and electrode sheets, the electrode sheets being alternatively arranged between the mica sheets and protruding lengthwise there from, first at one end and then at the other, to define zigzag electrode protrusions.

2. The mica capacitor according to claim 1, wherein said an insulation plates are alternatively arranged between the parallely-stacked basic laminates and protruding lengthwise there from, first at one end and then at the other, to define zigzag insulation protrusions.

3. The mica capacitor according to claim 2, further comprising a conductor filled in between same-ended pairs of insulation protrusions to allow only electrode protrusions in the basic laminate to be short-circuited.

4. The mica capacitor of claim 1, wherein a non-protruding end of said electrode sheets form gaps between opposing mica sheets.

5. The mica capacitor of claim 1, further comprising conductor filled in the uppermost basic laminate and the lowermost basic laminate of the stacked basic laminate toward the insulation protrusions.

6. The mica capacitor of claim 6, wherein the conductor is filled only in the uppermost basic laminate, and the lowermost basic laminate is connected to outside.

7. The mica capacitor of claim 3, further comprising insulation plates attached to an upper surface of an uppermost basic laminate and a lower surface of a lowermost basic laminate.

8. The mica capacitor of claim 1, wherein the conductor is a lead.

9. The mica capacitor of claim 1, wherein the electrode sheet is one of an an Ag paste or an electrode paper.

10. The mica capacitor of claim 1, wherein the mica sheet is in the thickness range of 0.01 mm˜0.1 mm.

11. The mica capacitor of claim 1, wherein the mica capacitor further includes a molding insulation that molds the basic laminate, the insulation plate and the conductor.

12. The mica capacitor of claim 1, wherein the molding insulation is made of epoxy material.

13. A method for fabricating a mica capacitor, comprising the steps of:
forming a basic laminate in which an electrode sheet is arranged between parallely stacked mica sheets to protrude in a zigzag manner;
arranging an insulation plate in which the basic laminates are parallely stacked, and an insulation plate protruding in a zigzag manner is formed between the basic laminates; and
filling a conductor between insulation protrusions each protruded toward the insulation plate.

14. The method of claim 13, further comprising a step of connecting terminals to a conductor filled only in an uppermost basic laminate and a lowermost basic laminate.

15. The method of claim 14, further comprising a step of molding the basic laminate, the insulation plate and the conductor in their entirety using molding insulation.

16. The method of claim 12, wherein the conductor is a lead.
